(19) United States
(12) Patent Application Publication
(10) Pub. No.: US 2021/0082431 A1
(43) Pub. Date: Mar. 18, 2021

(54) SYSTEMS AND METHODS FOR VOICE RECOGNITION

(71) Applicant: BEIJING DIDI INFINITY TECHNOLOGY AND DEVELOPMENT CO., LTD., Beijing (CN)

(72) Inventor: Rong ZHOU, Beijing (CN)

(73) Assignee: BEIJING DIDI INFINITY TECHNOLOGY AND DEVELOPMENT CO., LTD., Beijing (CN)

(21) Appl. No.: 17/103,903

(22) Filed: Nov. 24, 2020

Related U.S. Application Data
(63) Continuation of application No. PCT/CN2018/088422, filed on May 25, 2018.

(51) Int. Cl. G10L 15/22; G10L 15/02; G10L 15/16; G06N 3/04; G06N 3/08

(52) U.S. Cl. CPC G10L 15/22; G10L 15/02; G10L 2015/088; G06N 3/04; G06N 3/08; G10L 15/16

(57) ABSTRACT

The present disclosure is related to systems and methods for providing voice recognition. The method includes receiving a voice signal including a plurality of frames of voice data. The method also includes determining a voice feature for each frame, the voice feature being related to one or more labels. The method further includes determining one or more scores with respect to the one or more labels based on the voice feature. The method further includes sampling a plurality of frames in a pre-set interval. The method further includes obtaining a score of a label associated with each sampled frame. The method still further includes generating a command to wake up a device based on the obtained scores of the labels associated with the sampled frames.

### CROSS-REFERENCE TO RELATED APPLICATIONS

This application is a continuation of International Application No. PCT/CN2018/088422, filed on May 25, 2018, the entire contents of which are incorporated herein by reference.

### TECHNICAL FIELD

This disclosure generally relates to voice recognition system, and more particularly, relates to systems and methods for voice recognition using frame skipping.

### BACKGROUND

Voice recognition techniques are widely used in various fields, such as mobile terminals, smart homes, etc. The voice recognition techniques are used to wake up a target object (e.g., a device, a system, or an application) based on voice input by a user. When the voice input by the user is recognized to include a preset wake-up phrase, the target object is waken up from a sleep mode or a standby mode. However, as the voice recognition may be inaccurate, the false alarm may be generated to wake up the target object. Thus, it is desirable to develop a system and method for providing voice recognition more accurately.

### SUMMARY

According to an aspect of the present disclosure, a system for providing voice recognition is provided. The system may include at least one storage medium storing a set of instructions and at least one processor configured to communicate with the at least one storage medium. When executing the set of instructions, the at least one processor is directed to perform one or more of the following operations, for example, receive a voice signal including a plurality of frames of voice data; determine a voice feature for each of the plurality of frames, the voice feature being related to one or more labels; determine one or more scores with respect to the one or more labels based on the voice feature; sample a plurality of frames in a pre-set interval, the sampled frames corresponding to at least a part of the one or more labels according to a sequence of the one or more labels; obtain a score of a label associated with each sampled frame; and generate a command to wake up a device based on the obtained scores of the labels associated with the sampled frames.

In some embodiments, the at least one processor may be further directed to perform a smoothing operation on the one or more scores of the one or more labels for each of the plurality of frames.

In some embodiments, to perform a smoothing operation on one or more scores of one or more labels for each of the plurality of frames, the at least one processor may be directed to determine a smoothing window with respect to a current frame; determine at least one frame in the smoothing window associated with the current frame; determine scores of the one or more labels for the at least one frame; determine an average score of each of the one or more labels for the current frame based on the scores of the one or more labels for the at least one frame; and designate the average score of each of the one or more labels for the current frame as the score of each of the one or more labels for the current frame.

In some embodiments, the one or more labels may relate to a wake-up phrase for waking up the device, and the wake-up phrase may include at least one word.

In some embodiments, to determine one or more scores with respect to the one or more labels based on the one or more voice features, the at least one processor may be directed to determine a neural network model; input the one or more voice features corresponding to the plurality of frames into the neural network model; and generate one or more scores with respect to the one or more labels for each of the one or more voice features.

In some embodiments, to generate a command to wake up a device based on the obtained scores of the labels associated with the sampled frames, the at least one processor may be directed to determine a final score based on the scores of the one or more labels corresponding to the sampled frames; determine whether the final score is greater than a threshold; and in response to the determination that the final score is greater than the threshold, the at least one processor may be directed to generate the command to wake up the device.

In some embodiments, the final score may be a radication of a multiplication of the scores of the labels associated with the sampled frames.

In some embodiments, in response to the determination that the final score is not greater than the threshold, the at least one processor may be further directed to move the searching window a step forward.

In some embodiments, to determine one or more voice features for each of the plurality of frames, the at least one processor may be directed to transform the voice signal from a time domain to a frequency domain; and discretize the transformed voice signal to obtain the one or more voice features corresponding to the plurality of frames.

According to another aspect of the present disclosure, a method for providing voice recognition may be determined. The method may be implemented on a computing device having at least one processor and at least one computer-readable storage medium. The method may include, for example, receiving a voice signal including a plurality of frames of voice data; determining a voice feature for each of the plurality of frames, the voice feature being related to one or more labels; determining one or more scores with respect to the one or more labels based on the voice feature; sampling a plurality of frames in a pre-set interval, the sampled frames corresponding to at least a part of the one or more labels according to a sequence of the one or more labels; obtaining a score of a label associated with each sampled frame; and generating a command to wake up a device based on the obtained scores of the labels associated with the sampled frames.

According to still another aspect of the present disclosure, a non-transitory computer readable medium is provided. The non-transitory computer readable medium may include at least one set of instructions for providing voice recognition, wherein when executed by at least one processor of a computer device, the at least one set of instructions causes the computing device to perform a method. The method may include, for example, receiving a voice signal including a plurality of frames of voice data; determining a voice feature for each of the plurality of frames, the voice feature being related to one or more labels; determining one or more scores with respect to the one or more labels based on the voice feature; sampling a plurality of frames in a pre-set interval, the sampled frames corresponding to at least a part of the one or more labels according to a sequence of the one or more labels; obtaining a score of a label associated with each sampled frame; and generating a command to wake up a device based on the obtained scores of the labels associated with the sampled frames.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary voice recognition system according to some embodiments of the present disclosure;

FIG. 2 is a schematic diagram illustrating exemplary components of a computing device according to some embodiments of the present disclosure;

FIG. 3 is a schematic diagram illustrating exemplary hardware and/or software components of an exemplary user terminal according to some embodiments of the present disclosure;

FIG. 4 is a schematic diagram illustrating an exemplary processing engine according to some embodiments of the present disclosure;

FIG. 5 is a flow chart illustrating an exemplary process for generating a command to wake up a device according to some embodiments of the present disclosure;

FIG. 6 is a schematic diagram illustrating an exemplary processing module according to some embodiments of the present disclosure;

FIG. 7 is a flow chart illustrating an exemplary process for generating a command to wake up a device based on voice signals according to some embodiments of the present disclosure;

FIG. 8 is a flow chart illustrating an exemplary process for performing a smoothing operation on one or more scores of the one or more labels for a voice feature according to some embodiments of the present disclosure;

FIG. 9 is a flow chart illustrating an exemplary process for sampling a plurality of frames in a pre-set interval according to some embodiments of the present disclosure; and

FIG. 10 is a flow chart illustrating an exemplary process for generating a command to wake up the device according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

An aspect of the present disclosure is directed to systems and methods for providing voice recognition to wake up a target object such as a smart phone. To improve the accuracy and efficiency of the voice recognition, the present disclosure employs discrete sampling on the voice data including a plurality of frames to search for the wake-up phrase. Instead of frame-by-frame sampling, two sequential sampled frames may have a preset interval. Based on the score determined on the sequentially sampled frames, the false alarm due to the recognized partial wake-up phrase may be eliminated.

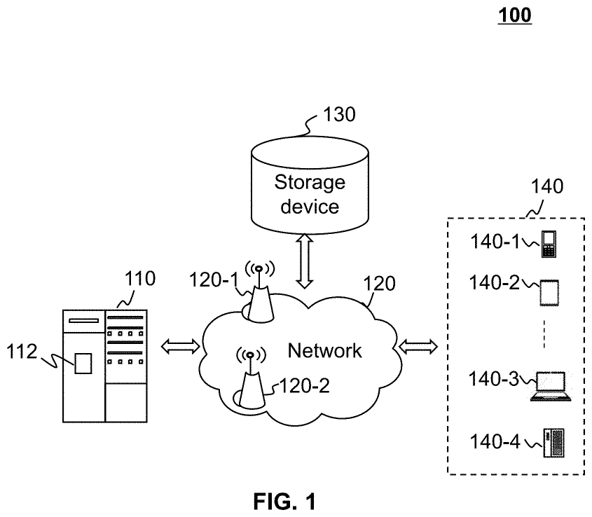

FIG. 1 is a schematic diagram of an exemplary voice recognition system according to some embodiments of the present disclosure. The voice recognition system 100 may include a server 110, a network 120, a storage device 130, and a user terminal 140.

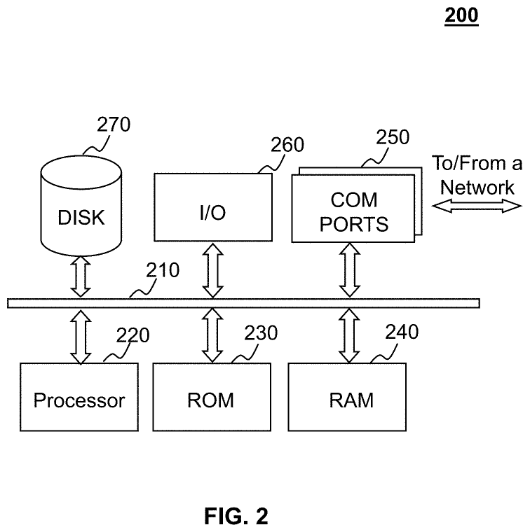

The server 110 may facilitate data processing for the voice recognition system 100. In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user terminal 140, and/or the storage device 130 via the network 120. As another example, the server 110 may be directly connected to the user terminal 140, and/or the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may determine one or more voice features for a plurality of frames of voice data. The voice data may be generated by a person, an animal, a machine simulation, or any combination thereof. As another example, the processing engine 112 may determine one or more scores with respect to one or more labels (e.g., one or more key words used to wake up a device) based on the one or more voice features. As still another example, the processing engine 112 may generate a command to wake up a device based on the voice data. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the voice recognition system 100 (e.g., the server 110, the storage device 130, and the user terminal 140) may send information and/or data to other component(s) in the voice recognition system 100 via the network 120. For example, the processing engine 112 may obtain a neural network model from the storage device 130 and/or the user terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the voice recognition system 100 may be connected to the network 120 to exchange data and/or information.

The storage device 130 may store data and/or instructions. In some embodiments, the storage device 130 may store data obtained from the user terminal 140 and/or the processing engine 112. For example, the storage device 130 may store voice signals obtained from the user terminal 140. As another example, the storage device 130 may store one or more scores with respect to one or more labels for the one or more voice features determined by the processing engine 112. In some embodiments, the storage device 130 may store data and/or instructions that the server 110 may execute or use to perform exemplary methods described in the present disclosure. For example, the storage device 130 may store instructions that the processing engine 112 may execute or use to determine a score. In some embodiments, the storage device 130 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 120 to communicate with one or more components in the voice recognition system 100 (e.g., the server 110, the user terminal 140, etc.). One or more components in the voice recognition system 100 may access the data or instructions stored in the storage device 130 via the network 120. In some embodiments, the storage device 130 may be directly connected to or communicate with one or more components in the voice recognition system 100 (e.g., the server 110, the user terminal 140, etc.). In some embodiments, the storage device 130 may be part of the server 110.

In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the voice recognition system 100 may be implemented on the user terminal 140.

It should be noted that the voice recognition system 100 is merely provided for the purposes of illustration, and is not intended to limit the scope of the present disclosure. For persons having ordinary skills in the art, multiple variations or modifications may be made under the teachings of the present disclosure. For example, the voice recognition system 100 may further include a database, an information source, or the like. As another example, the voice recognition system 100 may be implemented on other devices to realize similar or different functions. However, those variations and modifications do not depart from the scope of the present disclosure.

FIG. 2 is a schematic diagram illustrating exemplary components of a computing device on which the server 110, the storage device 130, and/or the user terminal 140 may be implemented according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the voice recognition system 100 as described herein. In FIGS. 1-2, only one such computer device is shown purely for convenience purposes. One of ordinary skill in the art would understood at the time of filing of this application that the computer functions relating to the voice recognition as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

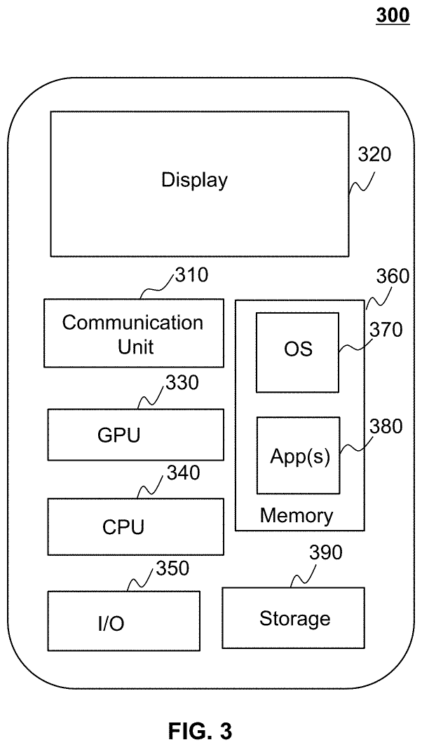

FIG. 3 is a schematic diagram illustrating exemplary hardware and/or software components of an exemplary user terminal according to some embodiments of the present disclosure; on which the user terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the location based service providing system on the mobile device 300. User interactions with the information stream may be achieved via the I/O devices 350 and provided to the processing engine 112 and/or other components of the voice recognition system 100 via the network 120.

In order to implement various modules, units and their functions described above, a computer hardware platform may be used as hardware platforms of one or more elements (e.g., a component of the sever 110 described in FIG. 2). Since these hardware elements, operating systems, and program languages are common, it may be assumed that persons skilled in the art may be familiar with these techniques and they may be able to provide information required in the route planning according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

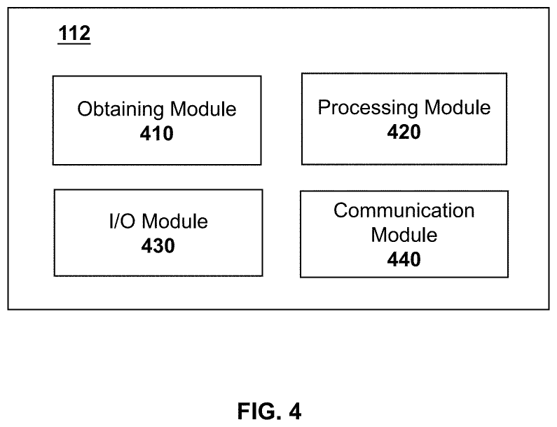

FIG. 4 is a schematic diagram illustrating an exemplary processing engine according to some embodiments of the present disclosure. The processing engine 112 may include an obtaining module 410, a processing module 420, an I/O module 430, and a communication module 440. The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application/set of instructions.

The obtaining module 410 may obtain data/signals. The obtaining module 410 may obtain the data/signals from one or more components of the voice recognition system 100 (e.g., the user terminal 140, the I/O module 430, the storage device 130, etc.), or an external device (e.g., a cloud database). Merely by ways of example, the obtained data/signals may include voice signals, wake-up phrases, user instructions, programs, algorithms, or the like, or a combination thereof. A voice signal may be generated based on a speech input by a user. As used herein, the “speech” may refer to a section of voice from a user that is substantially separated (e.g., by time, by meaning, and/or by a specific design of an input format) from other sections. In some embodiments, the obtaining module 410 may obtain a voice signal from the I/O module 430 or an acoustic device (e.g., a microphone of the user terminal 140), which may generate the voice signal based on voice of a user. The voice signal may include a plurality of frames of voice data. Merely by ways of example, the voice data may be or include information and/or characteristics of the voice signal in a time domain. In some embodiments, each frame may have a certain length. For example, a frame may have a length of 10 milliseconds, 25 milliseconds, or the like. As used herein, the wake-up phrase may refer to one or more words being associated with a target object (e.g., a device, a system, an application, etc.). The one or more words may include Chinese characters, words in English, phonemes, or the like, or a combination thereof, which may be separated by meaning, pronunciation, etc. In some embodiments, the target object may switch from one state to another state when a wake-up phrase is recognized by the voice recognition system 100. For example, when a wake-up phrase is recognized, a device may be waken up from a sleep state or a standby state.

In some embodiments, the obtaining module 410 may transmit the obtained data/signals to the processing module 420 for further processing (e.g., recognizing a wake-up phrase from a voice signal). In some embodiments, the obtaining module 410 may transmit the obtained data/signals to a storage device (e.g., the storage 327, the database 150, etc.) for storage.

The processing module 420 may process data/signals. The processing module 420 may obtain the data/signals from the obtaining module 410, the I/O module 430, and/or any storage devices capable of storing data/signals (e.g., the storage device 130, or an external data source). In some embodiments, the processing module 420 may process a voice signal including a plurality of frames of voice data, and determine whether one or more frames of the voice data include a wake-up phrase. In some embodiments, the processing module 420 may generate a command to wake up a target object if a wake-up phrase is recognized from a voice signal. In some embodiments, the processing module 420 may transmit processed data/signals to a target object. For example, the processing module 420 may transmit a command to an application to initiate a task. In some embodiments, the processing module 420 may transmit the processed data/signals to a storage device (e.g., the storage 327, the database 150, etc.) for storage.

The processing module 420 may include a hardware processor, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

The I/O module 430 may input or output signals, data or information. For example, the I/O module 430 may input voice data of a user. As another example, the I/O module 430 may output a command to wake up a target object (e.g., a device). In some embodiments, the I/O module 430 may include an input device and an output device. Exemplary input device may include a keyboard, a mouse, a touch screen, a microphone, or the like, or a combination thereof. Exemplary output device may include a display device, a loudspeaker, a printer, a projector, or the like, or a combination thereof. Exemplary display device may include a liquid crystal display (LCD), a light-emitting diode (LED)-based display, a flat panel display, a curved screen, a television device, a cathode ray tube (CRT), or the like, or a combination thereof.

The communication module 440 may be connected to a network (e.g., the network 120) to facilitate data communications. The communication module 440 may establish connections between the processing engine 112 and the user terminal 140, and/or the storage device 130. For example, the communication module 440 may send the command to the device to wake up a device. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G, etc.), or the like, or any combination thereof. In some embodiments, the communication port 207 may be and/or include a standardized communication port, such as RS232, RS485, etc.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. For example, the processing engine 112 may further include a storage module facilitating data storage. However, those variations and modifications do not depart from the scope of the present disclosure.

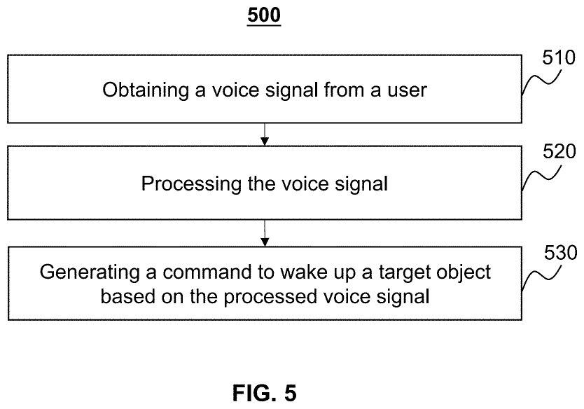

FIG. 5 is a flow chart illustrating an exemplary process 500 for generating a command to wake up a target object based on a voice signal according to some embodiments of the present disclosure. In some embodiments, the process 500 may be implemented in the voice recognition system 100. For example, the process 500 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 510, a voice signal may be obtained from a user. In some embodiments, the voice recognition system 100 may be implemented on a device (e.g., a mobile phone, a laptop, a tablet computer). The obtaining module 410 may obtain the voice signal from an acoustic component of the device. For example, the obtaining module 410 may obtain the voice of a user via an I/O port, for example, a microphone, of the device in real time, and generate a voice signal based on the voice of the user. In some embodiments, the voice signal may include a plurality frames of voice data.

In 520, the voice signal may be processed to determine a processing result. In some embodiments, the processing module 420 may perform various operations to determine the processing result (e.g., whether the voice data includes a wake-up phrase). In some embodiments, the voice signal may be transformed to a frequency domain from a time domain. In some embodiments, a voice feature for each of the plurality of frames of voice data may be determined. As used herein, a voice feature may refer to properties or characteristics of voice data in a frequency domain. In some embodiments, the voice feature may be extracted from voice data based on various voice feature extraction techniques. Exemplary voice feature extraction techniques may include Mel-scale Frequency Cepstral Coefficient (MFCC), Perceptual Linear Prediction (PLP), filter bank, or the like, or a combination thereof. In some embodiments, one or more scores with respect to one or more labels for each of one or more frames of voice data may be determined based on one or more voice features corresponding to the one or more frames of voice data. As used herein, the one or more labels may refer to key words of a wake-up phrase. For example, a wake-up phrase may include a first word “xiao” and a second word “ju”. The one or more labels being associated with the wake-up phrase “xiao ju” may include three labels, including, a first label, a second label, and a third label. The first label may represent the first word “xiao”. The second label may represent the second word “ju”. The third label may represent irrelevant words. In some embodiments, the processing results set forth above (e.g., the voice features, the one or more scores, etc.) may be used to wake up a target object (e.g., a device, a system, or an application) from a sleep state or a standby state.

In 530, the processing module 420 may generate a command to wake up the target object based on the processing results. In some embodiments, the processing module 420 may determine whether to wake up the target object based on the processing results (e.g., the one or more scores). If the processing module 420 recognizes a wake-up phrase based on the processing results, the processing module 420 may generate a command to switch the target object from one state to another state. For example, the processing module 420 may generate the command to activate the device from a sleep state or a standby state. As another example, the processing module 420 may generate the command to launch a particular application.

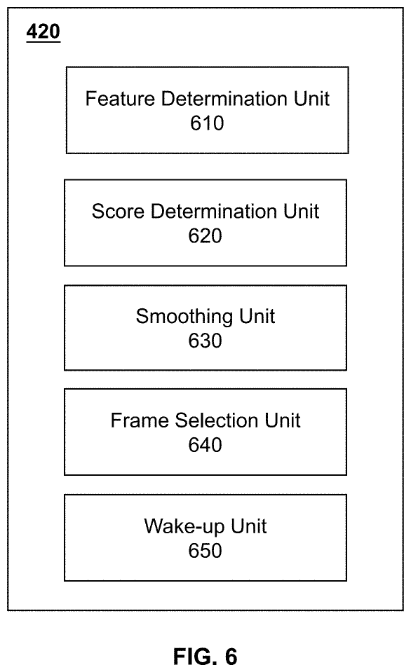

FIG. 6 is a schematic diagram illustrating an exemplary processing module 420 according to some embodiments of the present disclosure. In some embodiments, the processing module 420 may include a feature determination unit 610, a score determination unit 620, a smoothing unit 630, a frame selection unit 640, and a wake-up unit 650.

The feature determination unit 610 may determine a voice feature based on a frame of voice data. In some embodiments, the feature determination unit 610 may obtain a voice signal including a plurality of frames of voice data, and determine a voice feature for each of the plurality of frames based on the voice signal. During this process, the feature determination unit 610 may perform various operations to determine the voice features. Merely by ways of example, the operations may include Fast Fourier transform, spectral subtraction, filterbank extraction, low-energy transform, or the like, or a combination thereof.

The score determination unit 620 may determine one or more scores with respect to one or more labels for a frame. In some embodiments, the score determination unit 620 may obtain a voice feature corresponding to the frame from the feature determination unit 610. The score determination unit 620 may determine the one or more scores with respect to one or more labels for the frame based on the voice feature using a neural network model. The one or more labels may refer to key words of a wake-up phrase. For example, a wake-up phrase may include a first word “xiao” and a second word “ju”. The one or more labels being associated with the wake-up phrase “xiao ju” may include three labels, including, a first label, a second label, and a third label. The first label may represent the first word “xiao”. The second label may represent the second word “ju”. The third label may represent irrelevant words.

The score determination module 620 may obtain a neural network model from a storage device (e.g., the storage device 130) in the voice recognition system 100 and/or an external data source (e.g., a cloud database) via the network 120. The score determination module 620 may input the one or more voice features corresponding to the plurality of frames of voice data into the neural network model. The one or more scores with respect to the one or more labels for each frame may be generated in forms of the output of the neural network model.

In some embodiments, the scores with respect to the one or more labels for each of the plurality of frames determined in 730 may be stored in a score table. The score determination unit 620 may retrieve the score of the label associated with one or more frame sampled the frame selection unit 640 from the score table.

The smoothing unit 630 may perform a smoothing operation. In some embodiments, the smoothing unit 630 may perform the smoothing operation on the one or more scores of the one or more labels for each of the plurality of frames. In some embodiments, for each of the one or more voice features, the smoothing unit 530 may perform the smoothing operation by determining an average score of each of the one or more labels for the frame. In some embodiments, the average score may be determined in a smoothing window. The smoothing window may have a certain length, for example, 200 milliseconds.

The frame selection unit 640 may sample a plurality of frames in a pre-set interval. The pre-set interval between two sequential sampled frames may be a constant or a variable. For example, the pre-set interval may be 10 milliseconds, 50 milliseconds, 100 milliseconds, 140 milliseconds, 200 milliseconds, or other suitable values. In some embodiments, the pre-set interval may be associated with a time duration (e.g., 20 frames or 200 milliseconds) for a user to speak one word. In some embodiments, the sampled frames may correspond to at least a part of the one or more labels according to a sequence of the one or more labels.

The wake-up unit 650 may generate a command to wake up a target object (e.g., a device, a system, an application, or the like, or a combination thereof). The wake-up unit 650 may obtain the score of the label associated with one or more frame sampled the frame selection unit 640 from the score determination unit 620. In some embodiments, the wake-up unit 650 may generate a command to wake up the target object based on the determined scores of the labels associated with the sampled frames. If a preset condition for waking up the target object is satisfied, the wake-up unit 650 may transmit the command to the target object for controlling the status of the target object.

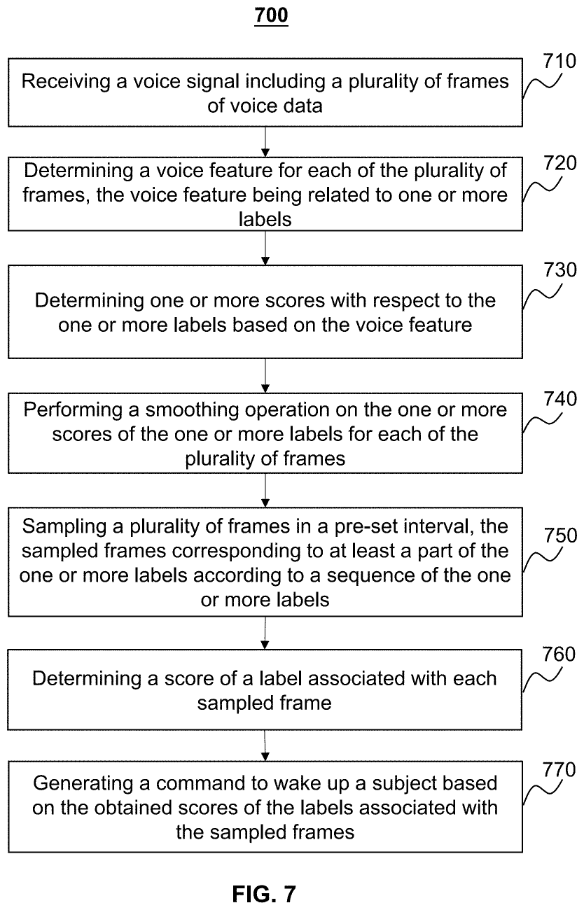

FIG. 7 is a flow chart illustrating an exemplary process 700 for generating a command to wake up a device based on a voice signal according to some embodiments of the present disclosure. In some embodiments, the process 700 may be implemented in the voice recognition system 100. For example, the process 700 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 710, a voice signal may be received. The voice signal may be received by, for example, the obtaining module 410. In some embodiments, the obtaining module 410 may receive the voice signal from a storage device (e.g., the storage device 130). In some embodiments, the voice recognition system 100 may receive the voice signal from a device (e.g., the user terminal 140). For example, the device may obtain voice of a user via an I/O port, for example, a microphone of the user terminal 140, and generate a voice signal based on the voice of the user.

In some embodiments, the voice signal may include a plurality frames of voice data. Each of the plurality frames may have a certain length. For example, a frame may have a length of 10 milliseconds, 25 milliseconds, or the like. In some embodiments, a frame may overlap at least a part of a neighboring frame. For example, a first frame ranging from 0 millisecond to 25 milliseconds may partially overlap a second frame ranging from 10 milliseconds to 35 milliseconds.

In 720, a voice feature for each of the plurality of frames may be determined. The voice feature for each of the plurality of frames may be determined by, for example, the feature determination unit 610. The feature determination unit 610 may determine a voice feature for each of the plurality of frames by performing a plurality of operations and/or analyses. Merely by ways of example, the operations and/or analyses may include Fast Fourier transform, spectral subtraction, filterbank extraction, low-energy transform, or the like, or a combination thereof. Merely for illustration purposes, the voice signal may be in a time domain. The feature determination unit 610 may transform the voice signal from the time domain to a frequency domain. For example, the feature determination unit 610 may perform a Fast Fourier transform on the voice signal to transform the voice signal from a time domain to a frequency domain. In some embodiments, the feature determination unit 610 may discretize the transformed voice signal. For example, the feature determination unit 610 may divide the transformed voice signal into multiple sections and represent each of the multiple sections as a discrete quantity.

In some embodiments, the feature determination module 610 may determine a feature vector for each of the plurality of frames based on the voice feature for each of the plurality of frames. Each feature vector may include multiple numerical values that represent the voice feature of the corresponding frame. For example, a feature vector may include 120 numbers. The numbers may represent features of the voice signal. In some embodiments, the numbers may range from 0 to 1.

In some embodiments, the voice feature may be related to one or more labels. In some embodiments, the one or more labels may be associated with a wake-up phrase. A target object (e.g., a device, a system, or an application) may switch from one state to another state when a wake-up phrase is recognized from the voice signal. For example, when a certain wake-up phrase is recognized, the voice recognition system 100 may wake up a device associated with the voice recognition system 100. The wake-up phrase may be set by a user via the I/O module 430 or the user terminal 140, or determined by the processing engine 112 according to default settings. For example, the processing engine 112 may determine, according to default settings, a wake-up phrase for waking up a device from a sleep state or a standby state, or for launching a particular application. Awake-up phrase may include one or more words. As used herein, a word may include a Chinese character, a word in English, a phoneme, or the like, which may be separated by its meaning, its pronunciation, etc. For example, a wake-up phrase may include a first word “xiao” and a second word “ju”. The one or more labels being associated with the wake-up phrase “xiao ju” may include three labels, including, a first label, a second label, and a third label. The first label may represent the first word “xiao”. The second label may represent the second word “ju”. The third label may represent irrelevant words. In some embodiments, the one or more labels may have a sequence. In some embodiments, the sequence of the labels may correspond to the sequence of the words in the wake-up phrase.

In 730, one or more scores with respect to the one or more labels for each frame may be determined based on voice features. The one or more scores may be determined by, for example, the score determination module 620. In some embodiments, the score determination module 620 may determine a neural network model. In some embodiments, the neural network model may include convolution neural network, deep neural network, or the like, or a combination thereof. For example, the neural network model may include a convolution neural network and one or more deep neural networks. In some embodiments, the score determination module 620 may train the neural network model using a plurality of wake-up phrases and corresponding voice signals, and store the trained neural network model in a storage device (e.g., the storage device 130) in the voice recognition system 100.

The score determination module 620 may input the voice features corresponding to the plurality of frames into the neural network model. One or more scores with respect to the one or more labels for each frame may be generated in forms of the output of the neural network model. For a specific frame, the one or more scores with respect to the one or more labels for the frame may represent the probabilities that the one or more words represented by the one or more labels may be present in the frame. The one or more scores may be integers, decimals, or the like, or a combination thereof. For example, a score with respect to a label for the voice feature may be 0.6. In some embodiments, a higher score of a label for a frame may correspond to a higher probability that the one or more words represented by the one or more labels may be present in the frame.

In 740, a smoothing operation may be performed on the one or more scores of the one or more labels for each of the plurality of frames. The smoothing operation may be performed by, for example, the smoothing unit 630. In some embodiments, for each of the plurality of frames, the smoothing unit 630 may perform the smoothing operation by determining an average score of each of the one or more labels for the each of the plurality of frames. In some embodiments, the average score may be determined in a smoothing window. The smoothing window may have a certain length, for example, 200 milliseconds.

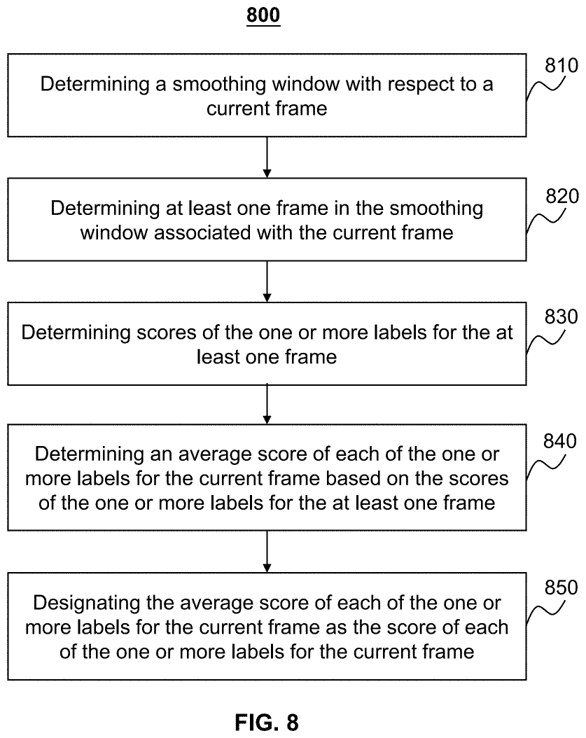

Merely for illustration purposes, for a specific label for a current frame, the smoothing unit 630 may determine at least one frame in the smoothing window associated with the current frame. The smoothing unit 630 may determine an average score of the label with respect to the at least one frame, and designate the average score as the smoothed score of the labels for the current frame. More descriptions regarding the smoothing operation may be found elsewhere in the present disclosure, for example, FIG. 8 and the descriptions thereof.

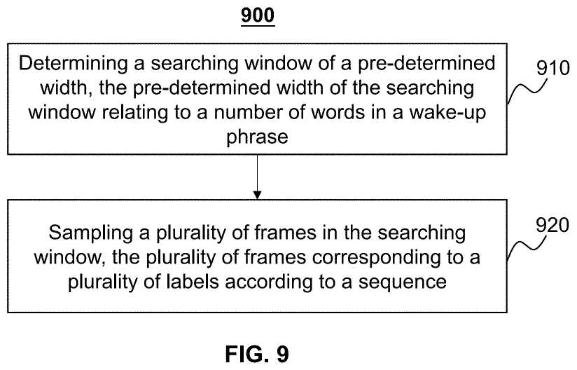

In 750, a plurality of frames may be sampled in a pre-set interval. The plurality of frames may be sampled by, for example, the frame selection unit 640. The pre-set interval between two sequential sampled frames may be a constant or a variable. For example, the pre-set interval may be 10 milliseconds, 50 milliseconds, 100 milliseconds, 140 milliseconds, 200 milliseconds, or other suitable values. In some embodiments, the pre-set interval may be associated with a time duration (e.g., 20 frames or 200 milliseconds) for a user to speak one word. In some embodiments, the pre-set interval may be determined according to default settings stored in a storage device (e.g., the storage device 130, the storage 390). In some embodiments, the pre-set interval may be adaptively adjusted according to different scenarios. For example, the frame selection unit 640 may determine the pre-set interval based on a language of the wake-up phrase, a speaking speed of a user, or the like, or a combination thereof. As another example, the frame selection unit 640 may determine the pre-set interval using a model, for example, a neural network model. More descriptions regarding the sampling of the plurality of frames may be found elsewhere in the present disclosure, for example, FIG. 9 and the descriptions thereof.

In some embodiments, the sampled frames may correspond to at least a part of the one or more labels according to a sequence of the one or more labels. Merely for illustration purposes, for four labels including a first label, a second label, a third label, and a fourth label (representing irrelevant words), three frames may be sampled, including a first sampled frame, a second sampled frame, and a third sampled frame. The first sampled frame, the second sampled frame, and the third sampled frame may correspond to the first label, the second label, and the third label, respectively. In some embodiments, the interval between the first sampled frame and the second sampled frame may be the same as or different from the interval between the second sampled frame and the third sampled frame.

In 760, a score of a label associated with each sampled frame may be determined. The score of a label associated with each sampled frame may be determined by, for example, the score determination unit 620. In some embodiments, the score determination unit 620 may determine the score of the label associated with each sampled frame by selecting, according to the sampled frames, from the scores with respect to the one or more labels for each of the plurality of frames determined in 730. For example, the scores with respect to the one or more labels for each of the plurality of frames determined in 730 may be stored in a score table. The score determination unit 620 may retrieve the score of the label associated with each sampled frame from the score table.

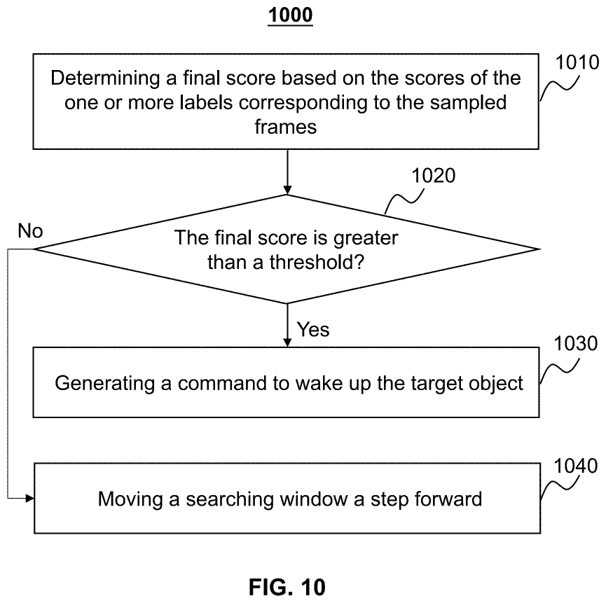

In 770, a command to wake up a target object may be generated based on the obtained scores of the labels associated with the sampled frames. The command to wake up the target object may be generated by, for example, the wake-up unit 650. In some embodiments, the wake-up unit 650 may determine a final score based on the obtained scores of the labels corresponding to the sampled frames. The wake-up unit 650 may determine whether to wake up the target object based on the final score and a threshold. For example, the wake-up unit 650 may determine whether the final score is greater than a threshold. If the final score is greater than the threshold, the wake-up unit 650 may generate the command to wake up the target object. If the final score is smaller than the threshold, the device may not wake up the target object. More descriptions regarding the determination of the final score and the waking up the device may be found elsewhere in the present disclosure, for example, FIG. 10 and the related descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. In some embodiments, one or more steps may be added or omitted. For example, the process 700 may further include an operation for generating a feature vector based on a voice feature corresponding to each frame. As another example, step 760 may be incorporated into step 750. As still another example, the one or more scores with respect to the one or more labels may be determined using other algorithms or mathematic models, which is not limiting. However, those variations and modifications do not depart from the scope of the present disclosure.

FIG. 8 is a flow chart illustrating an exemplary process 800 for performing a smoothing operation on one or more scores of the one or more labels for a voice feature according to some embodiments of the present disclosure. In some embodiments, the process 800 may be implemented in the voice recognition system 100. For example, the process 800 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, one or more operations in the process 800 may be performed by the smoothing unit 630.

In 810, a smoothing window with respect to a frame may be determined. As used herein, the smoothing window may refer to a time window in which the scores with respect to the one or more labels for a frame (also referred to as a “current frame”) may be smoothed. In some embodiments, the current frame may be included in the smoothing window. The smoothing window may have a certain width, for example, 100 milliseconds, 150 milliseconds, 200 milliseconds, etc. In some embodiments, the width of the smoothing window may relate to a time duration for speaking one word, for example, 200 milliseconds.

In 820, at least one frame in the smoothing window associated with the current frame may be determined. In some embodiments, the smoothing unit 630 may determine a plurality of frames adjacent to the current frame in the smoothing window. The number of the at least one frame may be set manually by a user, or be determined by one or more components of the voice recognition system 100 according to default settings. For example, the smoothing unit 630 may determine 10 sequential frames prior to the current frame in the smoothing window. As another example, the smoothing unit 630 may select 5 frames at a pre-set interval (e.g., 20 milliseconds) in the smoothing window. As another example, the smoothing unit 630 may select 5 frames at different intervals (e.g., the intervals between each two sequential selected frames may be 20 milliseconds, 10 milliseconds, 20 milliseconds, and 40 milliseconds, respectively) in the smoothing window.

In 830, the scores of the one or more labels for the at least one frame may be determined. In some embodiments, the determination of the scores of the one or more labels for the at least one frame may be similar to the operations in 730. In some embodiments, the smoothing unit 630 may obtain the scores of the one or more labels for the at least one frame from one or more components of the voice recognition system 100, for example, the score determination unit 620, or a storage device (e.g., the storage device 130).

In 840, an average score of each of the one or more labels for the current frame may be determined based on the scores of the one or more labels for the at least one frame. In some embodiments, the average score of a label for the current frame may be an arithmetic mean of the scores of the label for the determined at least one frame. For example, for each label for the current frame, the smoothing unit 630 may determine the average score of the label by dividing a sum of scores of the label for the at least one frame by the number of the at least one frame.

In 850, the average score of each of the one or more labels for the current frame may be designated as the score of each of the one or more labels for the current frame. For example, the smoothing unit 630 may designate an average value of scores with respect to a first label for 10 sequential frames prior to the current frame as the score with respect to the first label for the current frame.

In some embodiments, the operations in the process 800 may be repeated for a plurality of times to smooth scores of the one or more labels for the plurality of frames. Before another round for smoothing scores of the one or more labels for a next frame is initiated, the smoothing window may be moved a step forward. The length of the step may be a constant or a variable. For example, the smoothing window may be moved with a suitable width (10 milliseconds forward) to accommodate the next frame.

FIG. 9 is a flow chart illustrating an exemplary process 900 for sampling a plurality of frames in a pre-set interval according to some embodiments of the present disclosure. In some embodiments, the process 900 may be implemented in the voice recognition system 100. For example, the process 900 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the operations in the process 900 may be performed by the frame selection unit 640.

In 910, a searching window of a pre-determined width may be determined. As used herein, the searching window may refer to a time window in which a plurality of frames may be sampled. The searching window may include multiple frames. In some embodiments, the width of the searching window may be set by a user, according to default settings of the voice recognition system 100. In some embodiments, the width of the searching window may relate to the number of words in a wake-up phrase. To be specific, for a wake-up phrase including a first number of words, the width of the searching window may be a multiplication of the first number and a time duration for speaking one word. For example, for a wake-up phrase including two words, the searching window may have a length of 400 milliseconds (2×200 milliseconds).

In 920, a plurality of frames may be sampled in the searching window, the plurality of frames corresponding to a plurality of labels according to a sequence. In some embodiments, each two sequential sampled frames may have a pre-set interval as set forth above in 750. In some embodiments, the pre-set interval between two sequential sampled frames may be a constant, for example, 150 milliseconds, 200 milliseconds, etc. In some embodiments, the pre-set interval may relate to a time duration for speaking one word (e.g., 200 milliseconds).

The number of sampled frames in the searching window may be associated with the number of words in a wake-up phrase. For example, for a wake-up phrase “xiao ju”, the voice recognition system 100 may determine three labels including, for example, a first label (representing a first word “xiao”), a second label (representing a second word “ju”), and a third label (representing irrelevant words). The first label may be prior to the second label according to a relative position of the first word “xiao” and the second word “ju” in the wake-up phrase. Two frames may be sampled, including a first sampled frame and a second sampled frame. The first sampled frame and the second sampled frame may correspond to the first label and the second label, respectively. Thus, the first sampled frame (e.g., ranging from 0 millisecond to 10 milliseconds) may be prior to the second sampled frame (e.g., ranging from 140 milliseconds to 150 milliseconds) according to the sequence of the labels.

It should be noted that the above description is merely provided for the purposes of illustration, and not intended to limit the scope of the present disclosure. For persons having ordinary skills in the art, multiple variations and modifications may be made under the teachings of the present disclosure. For example, the pre-set interval between two sequential sampled frames may be adaptively adjusted according to the language of the wake-up phrase, the properties of the words in the wake-up phrase (e.g., the number of alphabets in the words), a speaking speed of a user. However, those variations and modifications do not depart from the scope of the present disclosure.

FIG. 10 is a flow chart illustrating an exemplary process 1000 for generating a command to wake up the device according to some embodiments of the present disclosure. In some embodiments, the process 1000 may be implemented in the voice recognition system 100. For example, the process 1000 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the operations in the process 1000 may be performed by the wake-up unit 650.

In 1010, a final score may be determined based on the scores of the one or more labels corresponding to the sampled frames. The final score may be a multiplication of the scores of the labels associated with the sampled frames, a summation of the scores of the labels associated with the sampled frames, a radication of a multiplication of the scores of the labels associated with the sampled frames, or the like. In some embodiments, the final score may be a radication of a multiplication of the scores of the labels associated with the sampled frames. The final score may be determined according to Equation (1):

$${P}_{value} = \sqrt[n]{{C}_{1} * {C}_{2} * … * {C}_{n}} , \qquad ( 1 )$$

where Pᵥₐₗᵤₑ denotes the final score, C₁ denotes a smoothed score of a first label associated with a first sampled frame, C₂ denotes a smoothed score of a second label associated with a second sampled frame, and Cₙ denotes a smoothed score of a n-th label associated with a n-th sampled frame.

In some embodiments, the final score may be determined according to Equation (2):

$${P}_{value} = \sqrt[I]{max {P}_{T}^{I}} \\ ( T = Sn , I = Wn ) , \qquad ( 2 )$$

where I denotes a I-th label corresponding to a I-th word in the wake-up phrase, T denotes a T-th frame, Sn denotes the width of the searching window, Wn denotes the number of words in the wake-up phrase, and max P_{T}^{I} denotes a maximum score of scores of the I-th label for the T-th frame. For the first frame in the voice signal, the max P_{T}^{I} may be determined according to Equation (3).

$$max {P}_{T}^{I} = \{ \begin{matrix}{Avg}_{t}^{i} & ( i = 1 , t = 1 ) \\ 0.0 & ( i != 1 , t != 1 )\end{matrix} , \qquad ( 3 )$$

For illustration purposes, for other frames except the first frames in the voice signal, the max P_{T}^{I} may be determined according to a computer code set forth below:

```
for t = 2, ..., Sₙ :
do
  for i = 1, 2, ..., Wₙ :
  do
    last_max = maxPₜ₋₁ⁱ
    cur_max = 0.0
    if i == 1:
      cur_max = Avgₜⁱ
    else:
      if t > N:
        cur_max = maxP_{t-N}ⁱ⁻¹ * Avgₜⁱ
      else:
        cur_max = 0.0
    if cur_max > last_max:
      maxPₜⁱ = cur_max
    else:
      maxPₜⁱ = last_max
  done
done
```

where Avgₜⁱ denotes an average score of an i-th label at a t-th frame in the searching window, and N denotes the pre-set interval between two sequential sampled frames.

In 1020, a determination may be made as to whether the final score is greater than a threshold. If the final score is greater than the threshold, the process 1000 may proceed to 1030 to generate the command to wake up the target object. If the final score is not greater than the threshold, the process 1000 may proceed to step 1040. The threshold may be a numerical number, for example, an integer, a decimal, etc. The threshold may be set by a user, according to default settings of the voice recognition system 100. In some embodiments, the threshold may relate to factors, such as the number of words in the wake-up phrase, the language of the wake-up phrase (e.g., English, Chinese, French, etc.), etc.

In 1030, a command to wake up a target object may be generated. If the final score is greater than the threshold, it may indicate that the frames in a searching window include a wake-up phrase. In some embodiments, the wake-up unit 650 may generate a command to switch the target object (e.g., a device, an component, a system, or an application) from a sleeping state or a standby state to a working state. In some embodiments, the wake-up unit 650 may generate a command to launch an app installed in the target object, for example, to initiate a search, schedule an appointment, generate a text or an email, make a telephone call, access a website, or the like.

In 1040, the searching window may be moved a step forward. If the final score is not greater than the threshold, it may indicate that the frames in the searching window do not include a wake-up phrase, and the searching window may be moved a step forward for sampling another set of frames. In some embodiments, the length of a step may be 10 milliseconds, 25 milliseconds, or the like. In some embodiments, the length of a step may be a suitable value (10 milliseconds) to accommodate the next voice feature. The length of the step may be set by a user, or be determined, according to default settings stored in a storage device (e.g., the storage device 130), by one or more components of the voice recognition system 100.

After the searching window is moved a step forward, 1010 through 1040 may be repeated to determine whether frames in the moved searching window includes a wake-up phrase. The process may terminate until the final score in the searching window is greater than the threshold, or the searching window passes through all the frames of the voice data. If the final score in the searching window is greater than the threshold, the process 1000 may proceed to 1030, and the wake-up unit 650 may generate the command to wake up the device. If the searching window passes through all the frames of the voice data, the process 1000 may come to an end.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

We claim:

1. A system for providing voice recognition, comprising:
at least one storage medium storing a set of instructions; and
at least one processor configured to communicate with the at least one storage medium, wherein when executing the set of instructions, the at least one processor is directed to:
receive a voice signal including a plurality of frames of voice data;
determine a voice feature for each of the plurality of frames, the voice feature being related to one or more labels;
determine one or more scores with respect to the one or more labels based on the voice feature;
sample a plurality of frames in a pre-set interval, the sampled frames corresponding to at least a part of the one or more labels according to a sequence of the one or more labels;
obtain a score of a label associated with each sampled frame; and
generate a command to wake up a device based on the obtained scores of the labels associated with the sampled frames.

2. The system of claim 1, wherein the at least one processor is further directed to:
perform a smoothing operation on the one or more scores of the one or more labels for each of the plurality of frames.

3. The system of claim 2, wherein to perform a smoothing operation on one or more scores of one or more labels for each of the plurality of frames, the at least one processor is directed to:
determine a smoothing window with respect to a current frame;
determine at least one frame in the smoothing window associated with the current frame;
determine scores of the one or more labels for the at least one frame;
determine an average score of each of the one or more labels for the current frame based on the scores of the one or more labels for the at least one frame; and
designate the average score of each of the one or more labels for the current frame as the score of each of the one or more labels for the current frame.

4. The system of claim 1, wherein the one or more labels relate to a wake-up phrase for waking up the device, and the wake-up phrase includes at least one word.

5. The system of claim 1, wherein to determine one or more scores with respect to the one or more labels based on the one or more voice features, the at least one processor is directed to:
determine a neural network model;
input the one or more voice features corresponding to the plurality of frames into the neural network model; and
generate one or more scores with respect to the one or more labels for each of the one or more voice features.

6. The system of claim 1, wherein to sample the plurality of frames in a pre-set interval, the at least one processor is directed to:
determine a searching window of a pre-determined width, the pre-determined width of the searching window relating to a number of words in a wake-up phrase; and
determine a number of frames in the searching window, the number of frames corresponding to a first number of labels according to the sequence.

7. The system of claim 6, wherein to generate a command to wake up a device based on the obtained scores of the labels associated with the sampled frames, the at least one processor is directed to:
determine a final score based on the scores of the one or more labels corresponding to the sampled frames;
determine whether the final score is greater than a threshold; and
in response to the determination that the final score is greater than the threshold,
generate the command to wake up the device.

8. The system of claim 7, wherein the final score is a radication of a multiplication of the scores of the labels associated with the sampled frames.

9. The system of claim 7, wherein the at least one processor is further directed to:
in response to the determination that the final score is not greater than the threshold,
move the searching window a step forward.

10. The system of claim 1, wherein to determine one or more voice features for each of the plurality of frames, the at least one processor is directed to:
transform the voice signal from a time domain to a frequency domain; and
discretize the transformed voice signal to obtain the one or more voice features corresponding to the plurality of frames.

11. A method for providing voice recognition implemented on a computing device having one or more processors and one or more storage devices, the method comprising:
receiving a voice signal including a plurality of frames of voice data;
determining a voice feature for each of the plurality of frames, the voice feature being related to one or more labels;
determining one or more scores with respect to the one or more labels based on the voice feature;
sampling a plurality of frames in a pre-set interval, the sampled frames corresponding to at least a part of the one or more labels according to a sequence of the one or more labels;
obtaining a score of a label associated with each sampled frame; and
generating a command to wake up a device based on the obtained scores of the labels associated with the sampled frames.

12. The method of claim 11, further comprising performing a smoothing operation on the one or more scores of the one or more labels for each of the plurality of frames.

13. The method of claim 12, wherein performing a smoothing operation on one or more scores of one or more labels for each of the plurality of frames comprises:
determining a smoothing window with respect to a current frame;
determining at least one frame in the smoothing window associated with the current frame;
determining scores of the one or more labels for the at least one frame;
determining an average score of each of the one or more labels for the current frame based on the scores of the one or more labels for the at least one frame; and
designating the average score of each of the one or more labels for the current frame as the score of each of the one or more labels for the current frame.

14. The method of claim 11, wherein the one or more labels relate to a wake-up phrase for waking up the device, and the wake-up phrase includes at least one word.

15. The method of claim 11, wherein determining one or more scores with respect to the one or more labels based on the one or more voice features comprises:
determining a neural network model;
inputting the one or more voice features corresponding to the plurality of frames into the neural network model; and
generating one or more scores with respect to the one or more labels for each of the one or more voice features.

16. The method of claim 11, wherein sampling the plurality of frames in a pre-set interval comprises:
determining a searching window of a pre-determined width, the pre-determined width of the searching window relating to a number of words in a wake-up phrase; and
determining a number of frames in the searching window, the number of frames corresponding to a first number of labels according to the sequence.

17. The method of claim 16, wherein generating a command to wake up a device based on the obtained scores of the labels associated with the sampled frames comprises:
determining a final score based on the scores of the one or more labels corresponding to the sampled frames;
determining whether the final score is greater than a threshold; and
in response to the determination that the final score is greater than the threshold,
generating the command to wake up the device.

18. The method of claim 17, further comprising:
in response to the determination that the final score is not greater than the threshold,
moving the searching window a step forward.

19. The method of claim 11, wherein determining one or more voice features for each of the plurality of frames comprises:
transforming the voice signal from a time domain to a frequency domain; and
discretizing the transformed voice signal to obtain the one or more voice features corresponding to the plurality of frames.

20. A non-transitory computer readable medium, comprising at least one set of instructions for providing voice recognition, wherein when executed by one or more processors of a computing device, the at least one set of instructions causes the computing device to perform a method, the method comprising:
receiving a voice signal including a plurality of frames of voice data;
determining a voice feature for each of the plurality of frames, the voice feature being related to one or more labels;
determining one or more scores with respect to the one or more labels based on the voice feature;
sampling a plurality of frames in a pre-set interval, the sampled frames corresponding to at least a part of the one or more labels according to a sequence of the one or more labels;
obtaining a score of a label associated with each sampled frame; and
generating a command to wake up a device based on the obtained scores of the labels associated with the sampled frames.
